(19) United States
(12) Patent Application Publication
(10) Pub. No.: US 2009/0037419 A1
(43) Pub. Date: Feb. 5, 2009

(54) Website exchange of personal information keyed to easily remembered non-alphanumeric symbols

(76) Inventor: Johannes Huber, New York, NY (US)

Correspondence Address: Russ Weinzimmer, 614 Nashua St. #204, Milford, NH, 03055, US

(21) Appl. No.: 11/890,019

(22) Filed: Aug. 3, 2007

(51) Int. Cl. G06F 17/30

(52) U.S. Cl. 707/9; 707/E17.001

(57) ABSTRACT

A website and method of use are disclosed for providing access to personal data upon entry of an access key that includes at least one easily remembered non-alphanumeric symbol. In some embodiments an incorrect or partial access key can be entered, or one of several access key variants can be entered. In some embodiments a subset of the personal data is provided and the presentation format is selected according to the variant of the access key that is entered. Methods for entering non-alphanumeric symbols include selection of characteristics from hierarchical menus, entering unique alphanumeric strings corresponding to symbols, selecting squares from a matrix, combining symbols to form compound symbols, combining text with symbols, and uploading symbols. In preferred embodiments, access information is entered and/or personal information is supplied audibly, hyperlinks to other personal data sites can be included, and automated web searches can identify candidates for links to other sites.

### FIELD OF THE INVENTION

The invention generally relates to means and methods for exchanging personal information, and more specifically to means and methods for providing access to personal information on a website.

### BACKGROUND OF THE INVENTION

The exchange of names, addresses, and other contact information is necessary to form and maintain both business and personal relationships. This exchange is often facilitated through the use of business cards, resumes, portfolios, prospectuses, and other documents, which can be distributed either in printed form or electronically via fax, email, or similar means. The exchange of such documents provides for convenient and consistent sharing of information in a well organized format that is easy for the desired recipient to comprehend.

A significant disadvantage of using documents to distribute personal information is that each time there is an addition, a deletion, or any other change to the personal information, a redistribution of corrected documents is needed in order to update the intended recipients. One approach to overcoming this problem is to maintain personal information in a database on a server, and provide appropriate instructions and access codes to intended recipients so that they can access the information by suitable means whenever needed. Then it is only necessary to keep the information on the server up to date in order to ensure that all intended recipients have access to the current information.

When all of the intended recipients have access to a common network, as often happens in a workplace environment, the personal information database can be placed on a server attached to the network, and the recipients can view and update the information using appropriate database software such as Microsoft Access or Symantec ACT. Intended recipients who have only sporadic access to the network can keep a copy of the database on a portable device such as a PDA or a laptop computer, and can use data synchronization methods to maintain consistency between their copy and the primary database. Obviously, this approach is problematic for the more general case where the information is to be distributed to a wide range of recipients who do not share access to a common network.

When very broad availability is desired, a more practical approach is to provide access to the personal information through a website posted on the worldwide web. It has become common for individuals to create personal web pages, which are often organized as sub-pages within a larger site created specifically for that purpose, such as MySpace.com, MyFace.com, YouTube.com, FaceBook.com, or the former Ecard.com (no longer active). Access to contact details and other personal information posted in this way only requires access to the internet and knowledge of the proper access codes. Through the use of web-enabled wireless devices, access is available at almost any time and from almost any location.

However, there are several difficulties with this approach as it exists in the current art. Since many individuals have names that are not unique, access to the personal information of a specific user typically requires that the intended recipient enter some sort of nickname or other coded information, such as “HogRider2400” or “JohnSmith2538.” These identifiers are often non-intuitive and difficult to remember. Due to the inevitable similarities between nicknames and identification codes, it is usually almost impossible to find the desired information if the intended recipient is not able to recall the precise access information.

In addition, many currently available personal information hosting websites are directed at specific groups of users, such as users that fall within certain age ranges, live in certain regions, or are interested in certain hobbies, music, sports, etc. The kinds of information provided by these sites and the manner in which it is presented is specifically targeted to the intended group, and may not be well suited to distributing information intended for a broader range of recipients. On the other hand, websites that are intended for a broad range of recipients do not include any means for controlling or tailoring the information for different types of recipients. For example, business contacts and personal acquaintances receive exactly the same information presented in exactly the same manner. Once the correct access code has been entered, all of the information is provided in a fixed format.

### SUMMARY OF THE INVENTION

A means and method for distributing personal information on a website is disclosed that uses visually creative and easily remembered non-alphanumeric symbols to identify users. In preferred embodiments, the symbols can be entered in any order, reducing the need for accurate recollection. In other preferred embodiments, symbols can be chosen that reflect characteristics and interests of the individual who has posted his or her personal information, herein referred to as the subscriber, and/or that correspond to an easily remembered story or phrase, thereby rendering them even easier to remember.

In some preferred embodiments, all of the symbols are chosen from a library of symbols provided by the website. In other preferred embodiments a user can create personalized symbols by adding arbitrary text to symbols and/or by combining symbols together to form compound symbols. In still further preferred embodiments, a user can create customized symbols by uploading new symbols to the website, either for restricted use or as new additions to the website symbol library.

In various preferred embodiments the methods for entering non-alphanumeric symbols include using a hierarchical system of menus to specify the shape, color, and other individual characteristics of each symbol, entry of unique alphanumeric codes that correspond to the non-alphanumeric symbols, and clicking on squares in a matrix to form unique patterns. A compound symbol is entered by using one or more of these methods to specify each of the symbols that combine to form the compound symbol.

In some preferred embodiments the identifying input required for accessing personal information, herein referred to as the “access key,” is composed entirely of non-alphanumeric symbols. In other preferred embodiments alphanumeric information, such as a password or a form of the individual's name, is also included as part of the access key.

In preferred embodiments, if an intended recipient does not have full recollection of an access key, and is therefore only able to input the key in a partial form or in a manner that is only partly correct, a list of candidate subscribers is generated. In some of these embodiments, if more than one candidate is found, the recipient is prompted to provide additional information, such as the name of the subscriber and/or the state where the subscriber resides, so as to narrow the search. In this way an intended recipient is frequently able to locate the desired subscriber information even when the access key is only partially known or remembered.

The website includes at least one gateway web page where intended recipients enter access keys. In preferred embodiments, the gateway web page also provides links to administrative web pages where subscribers enter passwords to gain access to their posted information and where new users subscribe, enter and post their personal information, specify access keys, specify their editing passwords, and enter all other required and optional information.

Some preferred embodiments allow a subscriber to specify multiple versions of his or her access key, thereby making it easier for an intended recipient to gain access after a few guesses even if the recipient has trouble accurately remembering the complete access key. In some of these preferred embodiments, subsets of the personal information are provided to intended recipients in varying formats depending on which version of the access key is entered. For example, in some preferred embodiments only data appropriate for a business contact or only data appropriate for a personal contact is provided, depending on the variant of the subscriber's access key that is entered.

In some preferred embodiments subscribers can include links to one or more other sites where they have posted personal information, such as MySpace.com, YouTube.com, MyFace.com, or Yahoo.com. In some of these preferred embodiments the links are hyperlinks that allow intended recipients to access the personal information on these other sites simply by clicking on the links. In further preferred embodiments, the website of this invention exchanges data with one or more other websites, so that when data is entered or updated on the website of this invention corresponding data on the linked sites is updated, and/or when data is updated on one of the other linked sites the corresponding data on the website of this invention is updated.

In still other preferred embodiments, users can create lists of frequently accessed subscribers that provide for quick access. In some of these embodiments, users who are not subscribers can become registered users of the website, allowing them to log onto the website for the purpose of creating and using lists of frequently accessed subscribers.

In some preferred embodiments, the website is voice enabled, such that alphanumeric strings corresponding to access key symbols can be input verbally by the recipient, and/or personal information can be provided audibly to the recipient by an automated voice.

Access keys can be distributed by subscribers to their intended recipients by any convenient means, including verbal communication, printed and electronic business cards and other documents, downloadable “v-cards,” SMS messages, email signatures, printing on advertisements, printing on clothing, etc. Because of their non-alphanumeric, graphical nature, it is possible to choose access keys that are easily remembered and easily recognized from a distance, as for example when printed on clothing or on an advertising poster.

### BRIEF DESCRIPTION OF THE DRAWINGS

FIG. 1A is an example of a non-alphanumeric access key of the invention;

FIG. 1B is an example of a business card used to distribute the access key of FIG. 1A to intended recipients;

FIG. 2A through FIG. 2D illustrate a hierarchical means of specifying non-alphanumeric access key symbols, and are respectively a collection of shapes, a collection of symbols applicable to the shapes, a collection of colors applicable to the shapes and symbols, and a collection of symbol variants, in this case facial expressions;

FIG. 2E illustrates the specification of a non-alphanumeric access key on a web-enabled cellular telephone.

FIG. 3A and FIG. 3B illustrate adding custom text to a symbol, with FIG. 3A illustrating the process and FIG. 3B showing the final result;

FIG. 4A through FIG. 4C illustrate a method of combining two symbols to form a compound symbol, with FIG. 4A illustrating the selection of a “frame” symbol, FIG. 4B showing the selection of a symbol to be placed inside of the frame symbol, and FIG. 4C showing the resulting compound symbol;

FIG. 5A is a matrix of squares that may be selected in unique combinations to create non-alphanumeric symbols for use as part of an access key;

FIG. 5B illustrates the specification of a WHZZZ key that is composed of a plurality of bars of varying color and thickness;

FIG. 6 is a preferred embodiment web page that allows a user to specify non-alphanumeric symbols either by invoking a hierarchical process, by entering a single alphanumeric code corresponding to a single symbol, or by entering two alphanumeric codes corresponding to the two components of a compound symbol, and that also requires an intended recipient to enter an access password in addition to the non-alphanumeric symbols to view the personal information of a subscriber;

FIG. 7A is a preferred embodiment web page that allows a user to specify non-alphanumeric symbols either by invoking a hierarchical process, by entering a single alphanumeric code corresponding to a single symbol, or by uploading an image to the website, and that also allows the subscriber to specify a list of access passwords, one of which must be entered by an intended recipient in order to view the subscriber's personal information;

FIG. 7B is a preferred embodiment menu that appears when the upload button of FIG. 7A is selected, allowing specification of the file to be uploaded and the usage permissions and alphanumeric code to be assigned to the uploaded image;

FIG. 8 is a preferred embodiment gateway web page that will accept entry of a partial or incomplete access key, in this case symbols without colors, will attempt to identify the desired subscriber by searching for matching access keys, and will prompt the recipient to provide additional information so as to further narrow the search if more than one candidate subscriber is found;

FIG. 9 is a block diagram of the website of the invention in a preferred embodiment;

FIG. 10 is a block diagram of a preferred embodiment that presents subsets of the personal information in different formats depending on the version of the access key that is entered by the intended recipient;

FIG. 11 is a preferred embodiment web page that displays links to other websites where the subscriber has stored personal information;

FIG. 12 is a preferred embodiment web page that displays a list of names and access keys belonging to frequently accessed subscribers; and

FIG. 13 is a flow chart that illustrates the method of use of the invention.

### DETAILED DESCRIPTION OF PREFERRED EMBODIMENTS

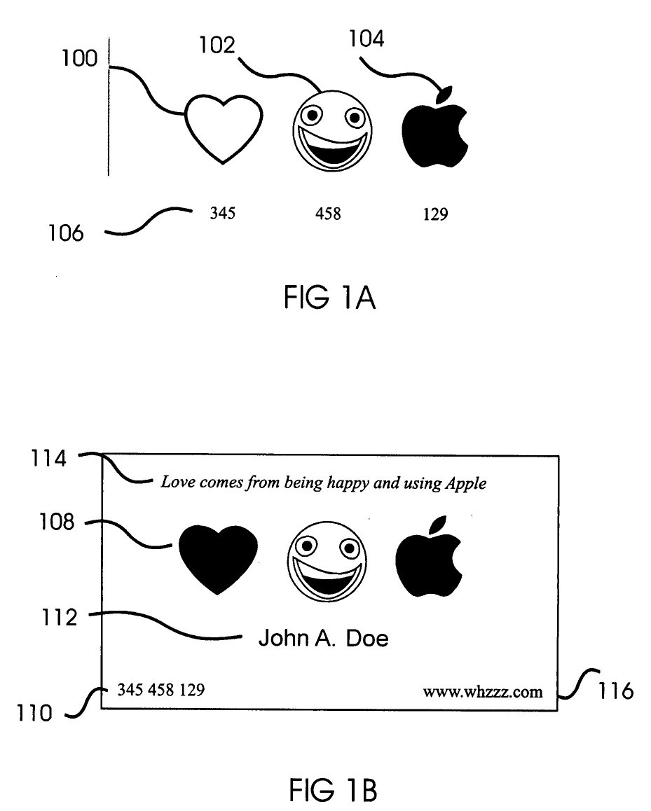

With reference to FIG. 1A, access keys include a plurality of non-alphanumeric symbols. In the example presented in FIG. 1A, the access key consists of a red heart 100, a yellow smiling face 102, and a red apple 104. Corresponding to each symbol is a three digit numerical code, 106, that may be entered as a method of selecting a symbol, and/or is displayed when a symbol is selected by another method. In other preferred embodiments alphanumeric codes of arbitrary length correspond to symbols, for example “HEARTR” for a red heart symbol. FIG. 1B presents an example of a business card used by a subscriber to provide the access key of FIG. 1A to intended recipients. The card includes the access key symbols 108, as well as the corresponding numeric codes 110, the name of the subscriber 112, a brief sentence 114 that can be used as a memory aid to remember the access key, and the website URL 116 where the personal information can be accessed.

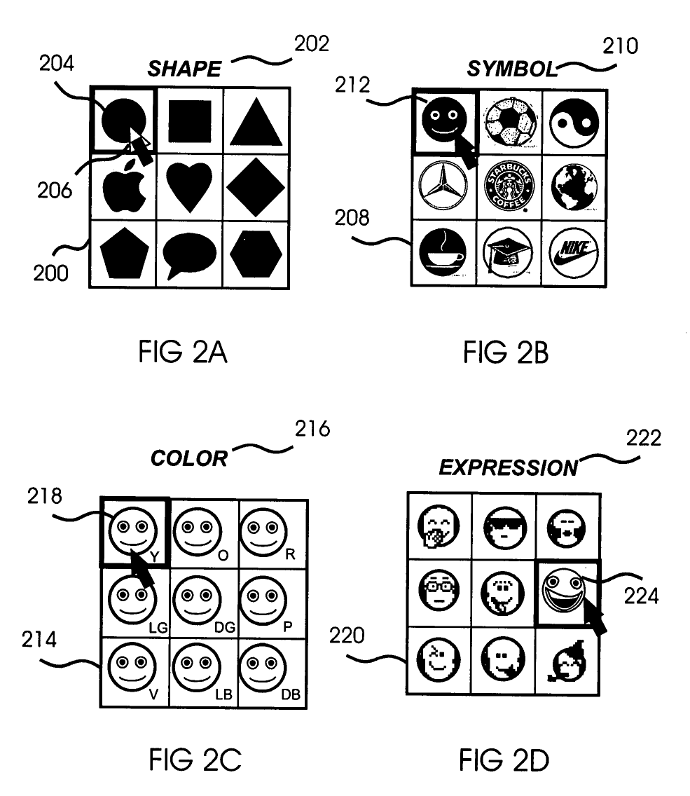

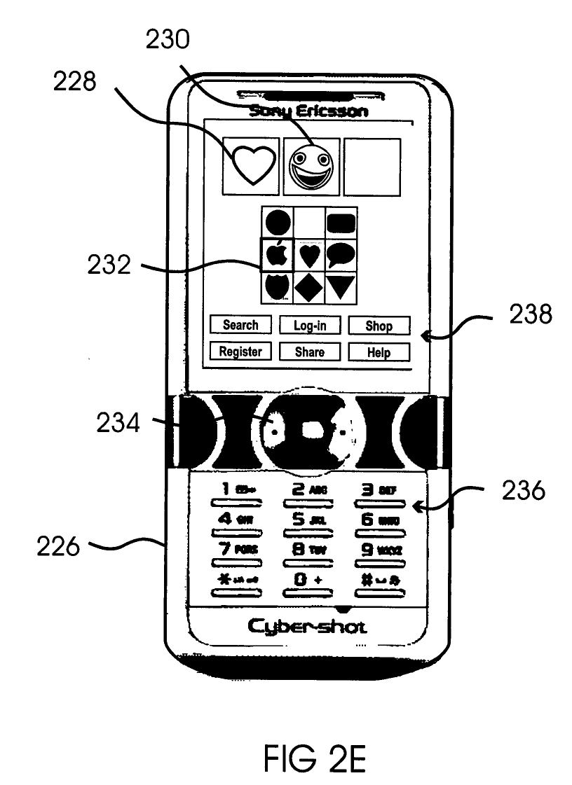

FIG. 2A through FIG. 2D present examples of hierarchical menus that are used in a preferred embodiment to select non-alphanumeric symbols by progressively specifying shape, color, and other characteristics. FIG. 2A presents a collection of basic shapes 200, with an appropriate topic label 202. In the figure, a circle 204 has been selected by positioning the mouse cursor 206 on the circle 204 and clicking the left mouse button. FIG. 2B presents a collection of symbols 208 that can be applied to the selected shape. The collection includes an appropriate topic label 210. A “smiling face” 212 has been selected using the mouse. FIG. 2C presents a collection 214 of circular smiling face symbols resulting from the choices made in FIG. 2A and FIG. 2B. In this collection, only the color varies between the choices, as indicated by the topic label 216. The upper left symbol 218, which is yellow, has been selected with the mouse. FIG. 2D presents a collection of symbol variations 220, in this case facial expressions, with an appropriate topic label 222. An open-mouthed expression 224 has been selected with the mouse. The final result of this hierarchical selection process is a yellow circle containing an open-mouthed smiling face, which is the second symbol 102 in the access key shown in FIG. 1A.

FIG. 2E illustrates a preferred embodiment in which a similar method is used to specify a non-alphanumeric access key using a web-enabled cellular telephone 226. In the figure, two non-alphanumeric symbols have been selected 228, 230, and a collection of basic shapes 232 similar to the collection 200 illustrated in FIG. 2A is being used to select the shape for the third symbol. Instead of a mouse, in this preferred embodiment the circular menu selecting control 234 is used to select a shape from the collection 232, and the numeric keys 236 are used to select other options and commands from a list 238.

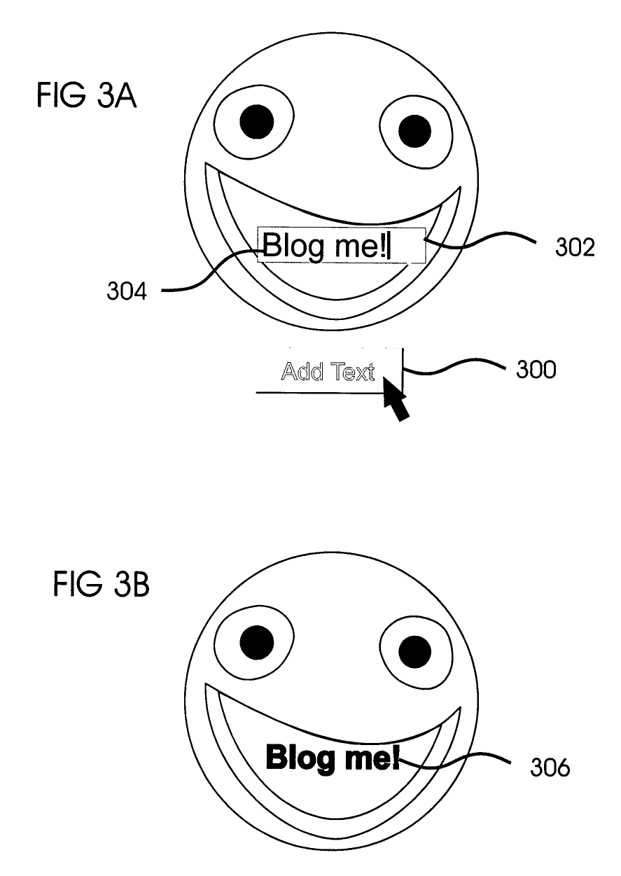

With reference to FIG. 3A and FIG. 3B, in preferred embodiments a symbol can be personalized by the addition of text. Clicking with the mouse on an “add text” button 300 as shown in FIG. 3A opens a text window 302 located on top of the symbol. Text is then entered 304 into the window and the input is terminated by striking the enter key. The result is shown in FIG. 3B, where the text “Blog me!” 306 has been added to the round, yellow smiling face specified by the steps illustrated in FIG. 2A through 2D.

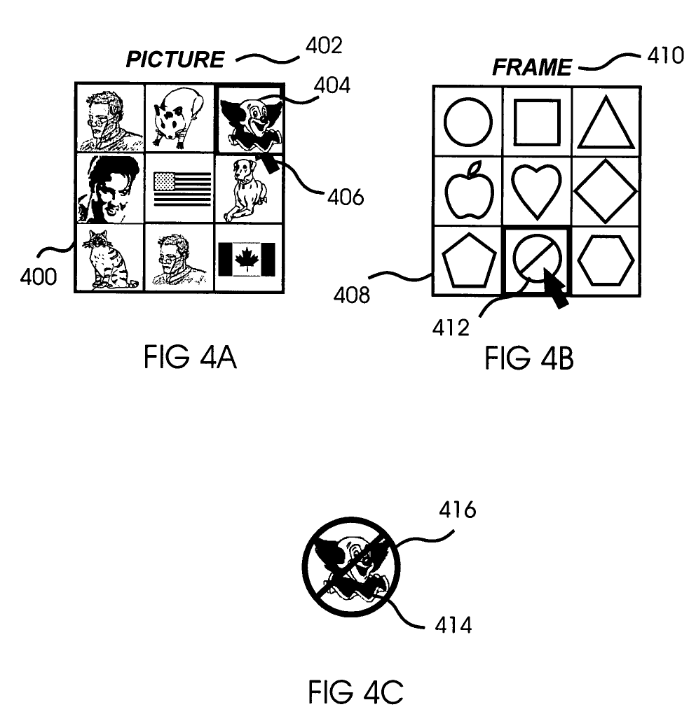

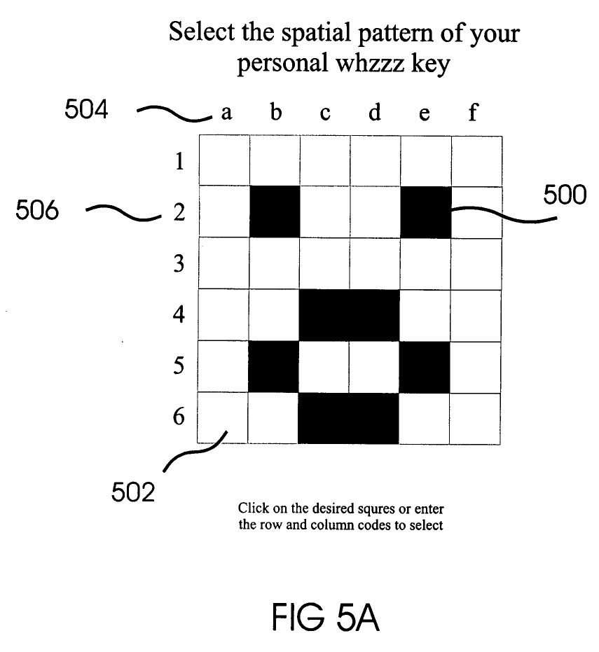

With reference to FIG. 4A through FIG. 4C, in some preferred embodiments custom symbols can be created by combining multiple symbols together to form a compound symbol. In the example shown in FIG. 4A through FIG. 4C, a compound symbol is formed by placing an inner “picture” symbol inside of an outer “frame” symbol. With reference to FIG. 4A, a menu of picture symbols is presented 400 with an appropriate heading 402. A picture of a clown 404 is selected by placing the mouse cursor 406 over the picture and clicking the left mouse button. Similarly, with reference to FIG. 4B, a menu of frame symbols is presented 408 with an appropriate heading 410, and a frame symbol consisting of a circle with a slash through it 412 is selected using the mouse. The result, shown in FIG. 4C, is the clown picture 414 with a circle and slash superimposed over it 416, possibly indicating that the user doesn't like clowns or doesn't want any “clowning around.”

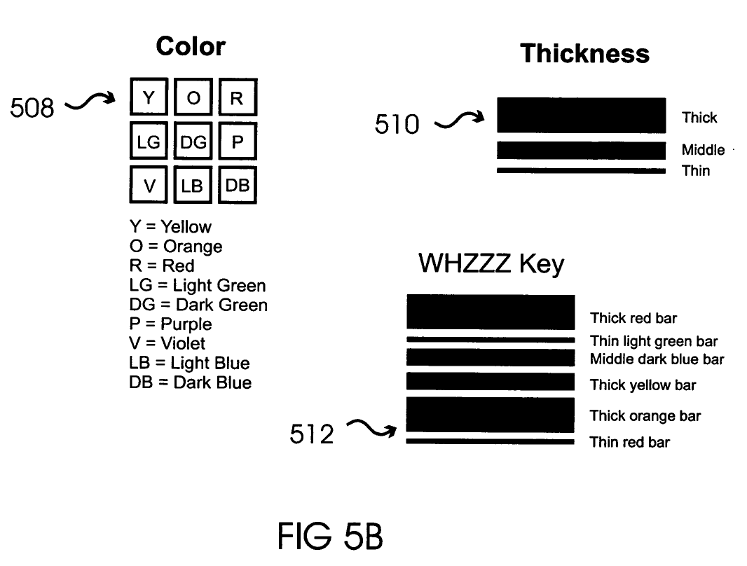

FIG. 5A shows a type of non-alphanumeric symbol, used in some preferred embodiments, that is based on a matrix of squares. For each of these matrix symbols some of the squares are selected 500 and others are not 502, forming a pattern of squares that is easy for a recipient to remember and reproduce. Creation of each matrix symbol is accomplished simply by clicking on the selected squares with the mouse or by typing in the horizontal 504 and vertical 506 coordinates of the selected squares. In the embodiment presented in FIG. 5, the squares are designated as being either white or gray. In other preferred embodiments, any of several colors can be assigned to each square, greatly increasing the number of possible symbols that can be generated.

FIG. 5B shows yet another type of non-alphanumeric symbol, used in some preferred embodiments, wherein each WHZZZ key is composed of a plurality of bars of varying color and thickness. In this preferred embodiment each bar in the WHZZZ key is specified by first clicking with the mouse on a color 508 and then on a bar thickness 510. In the preferred embodiment of FIG. 5B, each complete WHZZZ key 512 is composed of seven bars.

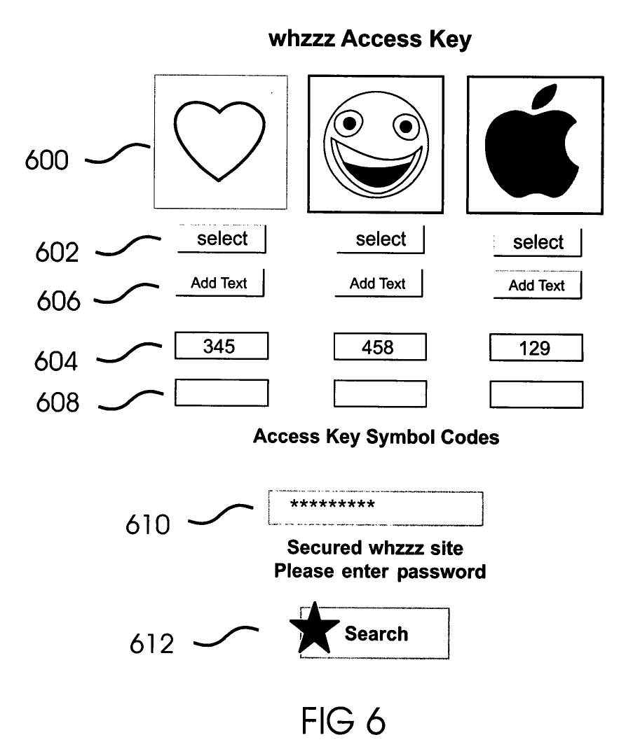

FIG. 6 shows a portion of a preferred embodiment gateway web page used by an intended recipient to gain access to a subscriber's personal information. In this preferred embodiment, each access key is composed of three symbols 600. The recipient can enter the symbols by clicking on the “select” button at each symbol position 602, thereby initiating a hierarchical selection method such as the one illustrated in FIG. 2A through FIG. 2D. As an alternative, the recipient can enter the alphanumeric codes 604 that correspond to the symbols into the spaces provided. The recipient can personalize a symbol by clicking on the “Add Text” button 606 under the symbol and adding text to the symbol, as illustrated in FIG. 3. By clicking on the “select” button 602 a second time, or by entering a second alphanumeric code in the space provided 608, the recipient can specify a compound symbol by adding a second symbol to the one already entered. In the preferred embodiment illustrated by FIG. 6, it is also necessary for the recipient to enter a password 610 before clicking on the search button 612 to locate the subscriber's information.

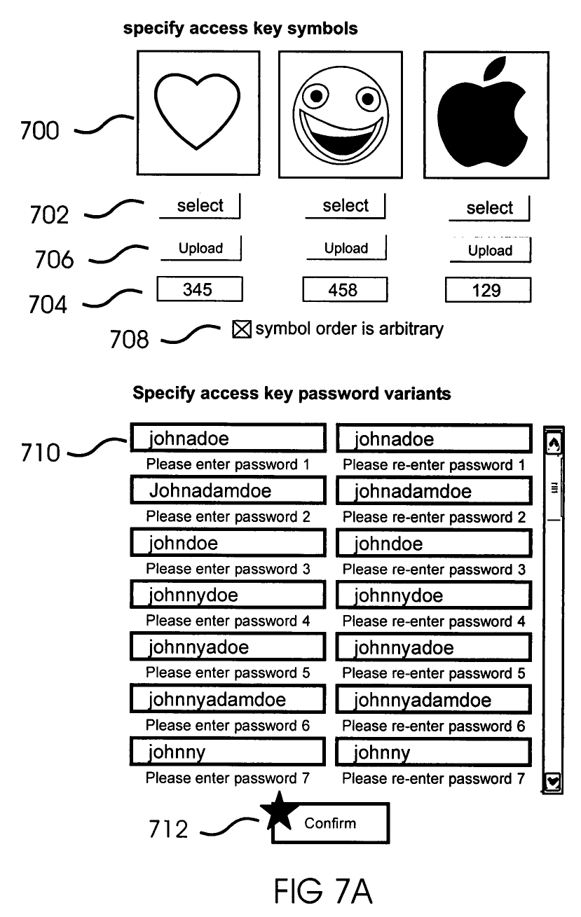

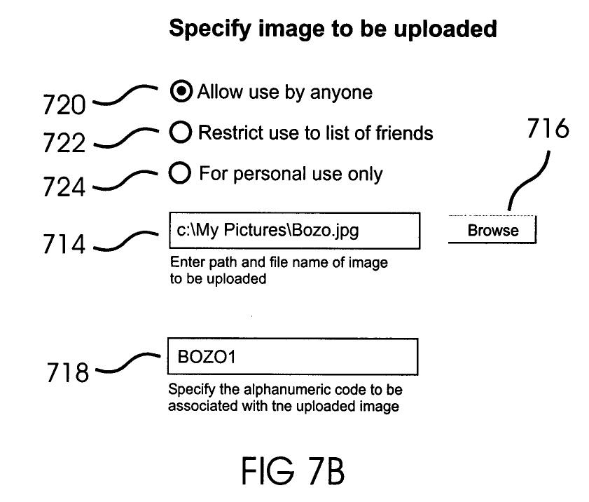

FIG. 7A shows a portion of a preferred embodiment gateway web page used by a subscriber to specify the access key for his or her personal information. The non-alphanumeric symbol part of the access key 700 is specified by clicking on the “select” buttons 702 or by entering corresponding alphanumeric codes 704, in the same manner as described with reference to FIG. 6 above. In the embodiment of FIG. 7, the subscriber also has the option of clicking on the “upload” buttons 706 and uploading symbols to be used as part of his or her access key. The subscriber can also select a checkbox 708 that allows intended recipients to enter the symbols in any order, thereby making it easier for a recipient to gain access even if the recipient has trouble remembering the correct symbol order.

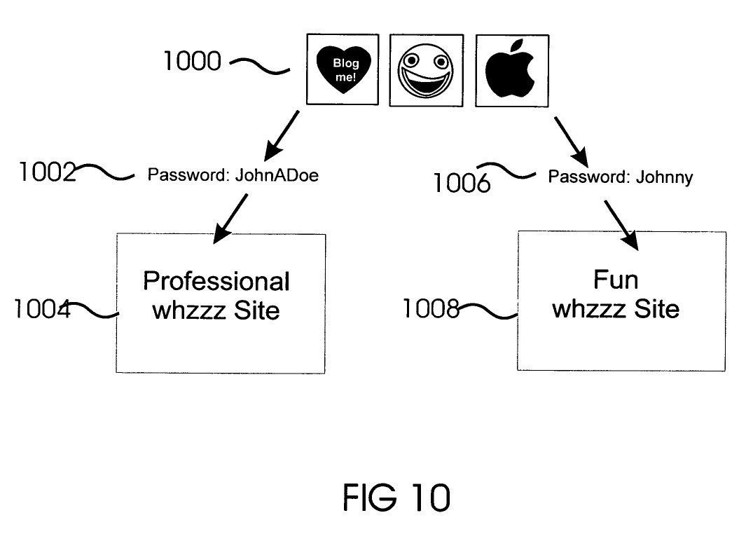

In the embodiment of FIG. 7A, the subscriber can specify an arbitrary number of passwords 710 and store them by clicking on the “confirm” button 712. If more than one password is specified, this indicates that a recipient can enter any one of them, thereby making it easier for an intended recipient to gain access even if the recipient has trouble remembering the correct form of the password. As is further discussed with reference to FIG. 10 below, in some preferred embodiments a similar option allows the subscriber to provide specific subsets of the personal data in specific formats to different recipients according to the password that is entered by the recipient.

FIG. 7B shows a menu of a preferred embodiment that is displayed when one of the “Upload” buttons 706 shown in FIG. 7A is clicked. A space is provided 714 for the subscriber to enter the path and filename of the image file to be uploaded. As an alternative, the subscriber can click on a “browse” button” 716 and use a standard Windows directory browsing menu to locate the file. In this embodiment, the user can also enter an alphanumeric code 718 that will be associated with the uploaded symbol so as to allow easy entry of the symbol. A set of radio buttons 720, 722, and 724, is also provided to allow the subscriber to specify who may use the uploaded symbol. An uploaded symbol may be of general interest to all subscribers, in which case the first button 720 is selected. Or a symbol may be of interest only to a select group, for example if the symbol is a picture of one of the subscriber's teachers or the logo of a local club that the subscriber belongs to. In this case the second button 722 is selected. There may also be symbols, such as the subscriber's own picture, that the subscriber wants to restrict to personal use only. For these cases the third button 724 is selected.

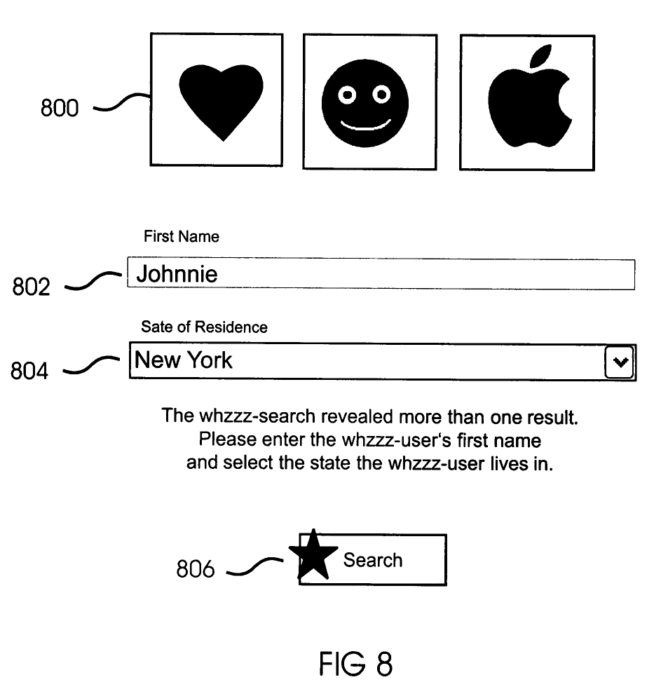

FIG. 8 shows a portion of a preferred embodiment gateway web page that allows an intended recipient who has trouble correctly remembering the complete access key to enter an incomplete or partially incorrect access key. In this embodiment entry of an access key that does not exactly match any of the access keys in the database of the website results in a search for partial matches. In the example illustrated in FIG. 8, three shapes have been entered 800 with no colors applied. If only one partial match is found, the corresponding personal information is displayed. If more than one partial match is found, the intended recipient is prompted to enter additional information, such as the subscriber's first name 802 and state of residence 804, and then to restart the search by clicking on the appropriate button 806. If the added information results in a unique match, the personal information of the matching subscriber is displayed.

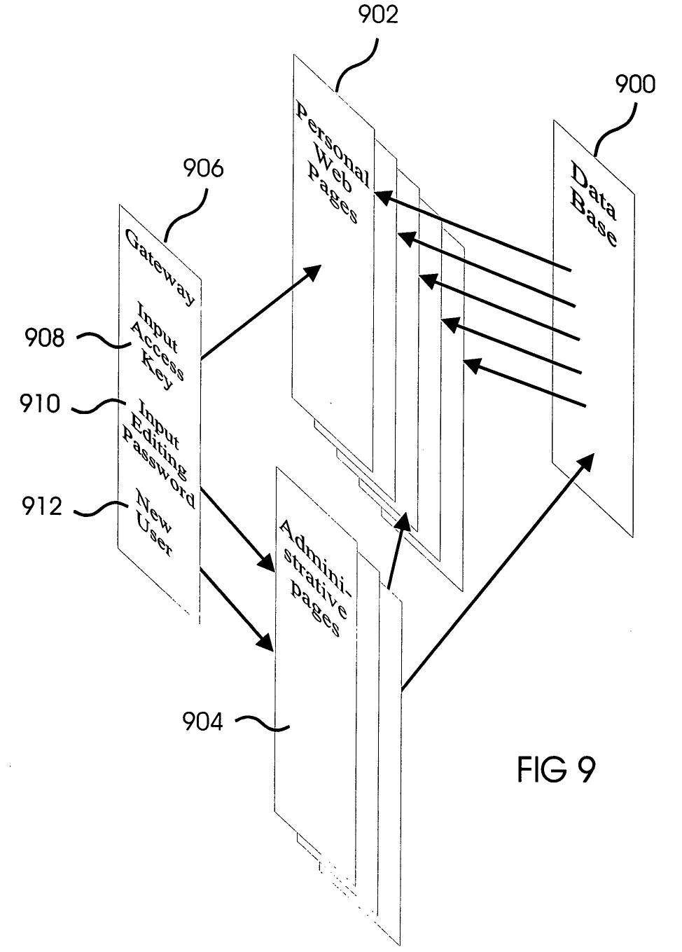

FIG. 9 presents a block diagram of the basic structure of the website of the invention, which includes at least one database 900 in which personal information is stored, a plurality of personal web pages 902 that are automatically generated and that display the personal information stored in the database 900, at least one administrative web page 904 that is used to create, edit, and delete information, and to add new subscribers, and at least one “gateway” web page 906 that is used to provide access to the other web pages. In order to view a personal information web page, a user must enter a correct access key into a gateway 908 web page. In all embodiments, the access key includes non-alphanumeric symbols. In some preferred embodiments, the access key also includes additional information, such as a password or the first and/or last name of the subscriber. In order to add, edit, and/or delete his or her personal information, a subscriber must enter a password or other suitable access information 910 into a gateway web page. A new user can choose to be directed 912 by a gateway to an administrative page where the new user can subscribe and enter his or her personal information, specify a unique access key, and input all other required and optional information.

FIG. 10 is a flow diagram that illustrates how, in a preferred embodiment; subsets of a subscriber's personal information are presented in different formats depending on the variant of the access password that is entered by the intended recipient. The recipient first enters the non-alphanumeric symbols 1000, and then enters a password as provided by the subscriber. The subscriber provides the password “JohnADoe” 1002 to business contacts, who enter this password and are presented with a web page designed in a conservative business style and containing a subset of the personal information 1004 that is deemed by the subscriber to be appropriate for business contacts. Similarly, the subscriber provides the password “Johnny” 1006 to personal contacts, who enter this password and are presented with a web page designed with a more contemporary format and containing a subset of the personal information 1008 that is deemed by the subscriber to be appropriate for personal contacts.

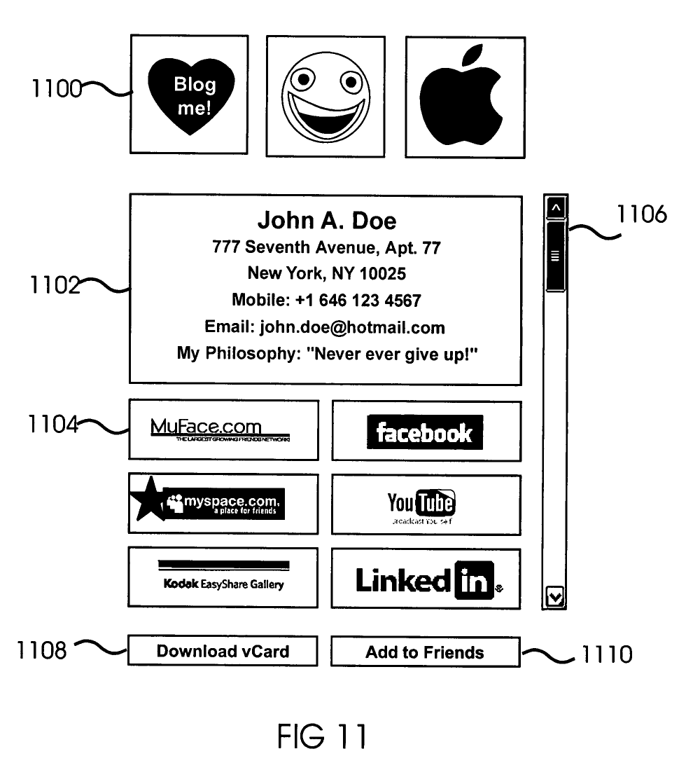

FIG. 11 shows a portion of a preferred embodiment web page that displays links to other personal information websites where the subscriber has stored information. Along with the access key 1 100 and personal information 1102, a list of links to other personal information sites 1104 is displayed. If the list is too long to be displayed, a scroll bar 1106 can be used to access additional entries. In some preferred embodiments, the links are hyperlinks that transfer the viewer to the linked site when clicked with the mouse. In some preferred embodiments the list of links is added manually by the subscriber, while in other preferred embodiments links can be selected by the subscriber from a candidate list generated by an automated internet search that looks for other sites where information pertaining to the subscriber appears to be located.

In the embodiment shown in FIG. 11, opportunities are provided to the viewer to download a vcard 1108 containing the subscriber's access information and to add the subscriber to the viewer's list of frequently viewed sites (“friends”) 1110.

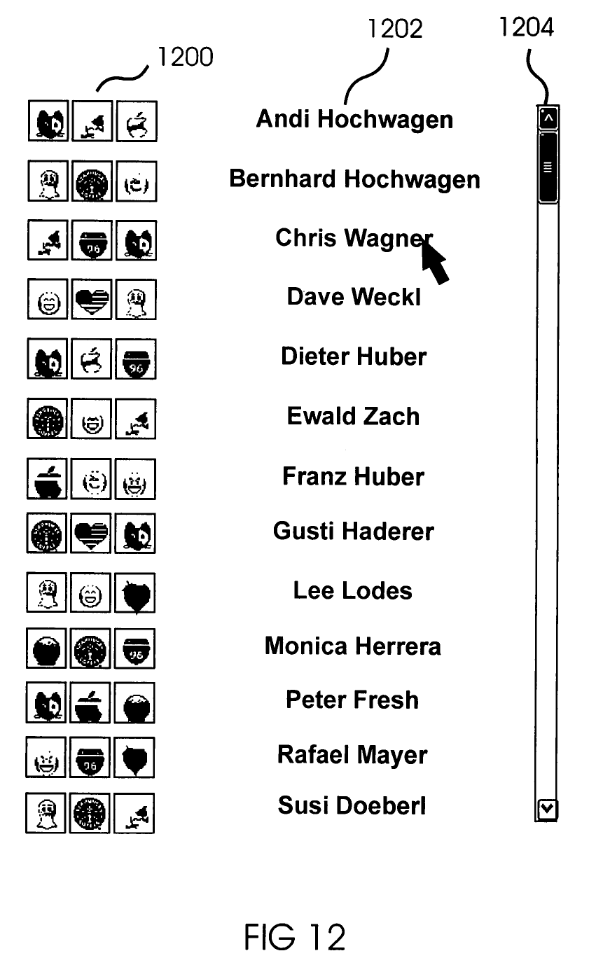

FIG. 12 shows a portion of a preferred embodiment web page that maintains and displays a list of access keys 1200 and names 1202 of frequently accessed subscribers (“friends”). If the list is too long to be displayed, a scroll bar 1204 can be used to access additional entries. In this preferred embodiment, non-subscribers are given the option of registering as users of the website, so that the website can recognize them each time they log in and can provide the correct list of “friends” to each user.

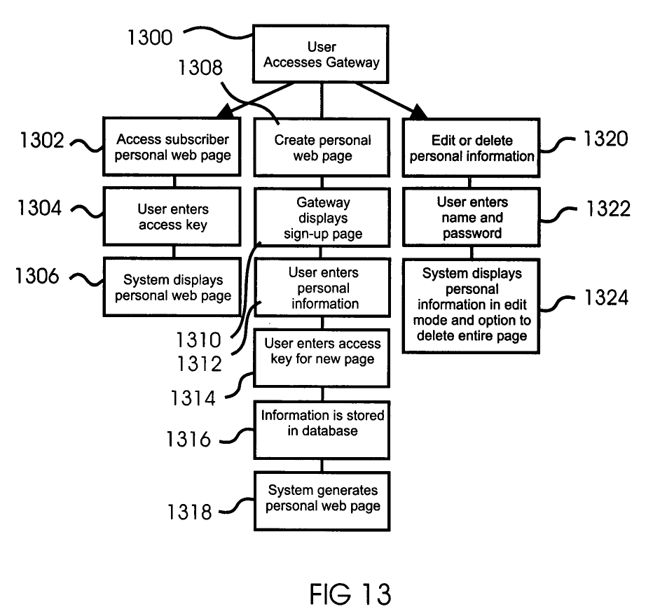

FIG. 13 is a flow diagram that illustrates the method of use of the invention. In all cases, usage begins by using a web browser to access a gateway web page 1300. An intended recipient 1302 enters the access key 1304 of a subscriber, and views the subscriber's personal information on a web page 1306 displayed by the website. A new subscriber creates a new personal web page 1308 by proceeding to the sign-up administrative page 1310 and entering his or her personal information 1312 into the database. The new subscriber also specifies the access key 1314 that will be used by intended recipients to access the information. Once entered, the information is stored by the system 1316 and in the preferred embodiment illustrated by FIG. 11 a new personal web page is generated and stored 1318. In other preferred embodiments, a personal web page is created each time an intended recipient is granted access. An existing subscriber can choose to add to, edit, or delete items 1320 from his or her personal information, including deletion of his or her entire record, by entering required access information, which in the preferred embodiment of FIG. 13 is the subscriber's name and password 1322. The system then displays the user's information in a mode appropriate for editing, and also offers the option to delete the entire record 1324.

Other modifications and implementations will occur to those skilled in the art without departing from the spirit and the scope of the invention as claimed. Accordingly, the above description is not intended to limit the invention except as indicated in the following claims.

What is claimed is:

1. A website for distributing personal information over the worldwide web, comprising:
a database that stores the personal information of subscribers, including a unique access key associated with each subscriber, each access key including at least one non-alphanumeric symbol;
at least one method for entering non-alphanumeric symbols;
at least one web page that provides access to personal information of a subscriber when the access key associated with the subscriber is entered;
at least one web page that enables a user to become a subscriber; and
at least one web page that enables a subscriber to add to, delete from, and edit the personal information of the subscriber stored in the database.

2. The website of claim 1, wherein the access key includes more than one non-alphanumeric symbol, and wherein the subscriber can specify that the non-alphanumeric symbols of the access key can be entered in more than one order.

3. The website of claim 1, wherein at least one of the methods for entering non-alphanumeric symbols includes the display of a hierarchical series of menus, each of which provides for the selection of a single graphical element of a symbol.

4. The website of claim 1, wherein at least one of the methods for entering non-alphanumeric symbols includes a method for entering text and combining the text with a symbol.

5. The website of claim 1, wherein at least one of the methods for entering non-alphanumeric symbols includes a method for uploading symbols to the website.

6. The website of claim 5, wherein access to uploaded symbols can be specified as being one of generally available to all users, available only to a restricted set of users, and available only to the subscriber that uploaded the image.

7. The website of claim 1, wherein at least one of the methods for specifying non-alphanumeric symbols includes selection within a plurality of locations of a subset of the locations.

8. The website of claim 7, wherein a color is assigned to each of the locations.

9. The website of claim 1, wherein at least one of the methods for specifying non-alphanumeric symbols includes specifying a plurality of bars that vary in at least one of color and thickness.

10. The website of claim 1, wherein unique strings of alphanumeric characters are associated with at least some of the non-alphanumeric symbols, and wherein at least one of the methods for entering non-alphanumeric symbols is entering the unique alphanumeric strings that correspond to the symbols.

11. The website of claim 1, wherein at least one of the methods for entering non-alphanumeric symbols includes entering a plurality of symbols that combine to form a compound symbol.

12. The website of claim 1, wherein at least one of the methods for entering access keys is by audible input.

13. The website of claim 1, wherein personal information of a subscriber can be provided audibly.

14. The website of claim 1, wherein at least some of the access keys include at least one access password.

15. The website of claim 1, wherein at least some of the access keys include a plurality of access key variants, and wherein entry of an access key that includes a plurality of access key variants requires entry of only one of the access key variants.

16. The website of claim 15, wherein access key variants can be associated with subsets of the corresponding personal information, and wherein only the associated subset of personal information is provided upon entry of an access key variant.

17. The website of claim 15, wherein access key variants can be associated with formats for providing personal information, and wherein personal information is provided in the associated format upon entry of an access key variant.

18. The website of claim 1, wherein partial entry of an access key results in a search for candidate subscribers with access keys that match the partial access key that was entered.

19. The website of claim 18, wherein when only one candidate subscriber is found, access to the personal information for that subscriber is provided.

20. The website of claim 18, wherein when more than one candidate subscriber is found, additional information is requested, and upon submission of the additional information a new search for candidate subscribers is initiated.

21. The website of claim 1, wherein the personal information of a subscriber can include links to other websites that also contain information pertaining to the subscriber.

22. The website of claim 21, wherein the links to other websites are presented to as hyperlinks that can automatically transfer users to the linked sites.

23. The website of claim 21, wherein the website can perform an internet search of other websites and generate a list of candidate links to other sites that appear to contain information pertaining to a subscriber.

24. The website of claim 21, wherein information can be automatically exchanged between the database of the present invention and at least one other website that contains information pertaining to at least one subscriber, so as to update the information on at least one of the database of the present invention and the at least one other website.

25. The website of claim 24, wherein the exchange of information is automatically initiated when pertinent information is changed in at least one of the database of this invention and the at least one other website.

26. The website of claim 24, wherein data comparisons and data updates between the database of this invention and the at least one other website are automatically initiated at defined time intervals.

27. The website of claim 1, wherein at least one of the web pages that enables a subscriber to add to, delete from, and edit the personal information of the subscriber stored in the database includes a requirement that a password be entered.

28. The website of claim 1, wherein at least some of the personal information can be downloaded from the website once access has been granted.

29. A method for distributing personal information over the worldwide web, comprising:
Posting a website on the worldwide web that stores the personal information of subscribers, including a unique access key associated with each subscriber, each access key including at least one non-alphanumeric symbol, the website also providing at least one method for entering non-alphanumeric symbols, the website also including at least one web page that provides access to personal information of a subscriber when the access key associated with the subscriber is entered, the website also including at least one web page that enables a user to become a subscriber, and the website also including at least one web page that enables a subscriber to add to, delete from, and edit the personal information of the subscriber stored on the website;
entering by a subscriber of personal information into the website;
specifying by the subscriber of an access key;
providing by the subscriber of the access key and the address of the website to at least one intended recipient;
accessing of the website by an intended recipient;
entering of the access key by the intended recipient into the website; and
providing of the personal information by the website to the intended recipient.
